(19) United States
(12) Patent Application Publication
(10) Pub. No.: US 2024/0235846 A1
(43) Pub. Date: Jul. 11, 2024

(54) MANAGING CRYPTOGRAPHIC COMPLIANCE ON A COMPUTING DEVICE USING A DISTRIBUTED LEDGER

(71) Applicant: VMware, Inc., Palo Alto, CA (US)

(72) Inventors: Sean James Huntley, Sydney (AU); David Ott, Palo Alto, CA (US); Daniel Beveridge, Valrico, FL (US)

(21) Appl. No.: 18/094,431

(22) Filed: Jan. 9, 2023

(51) Int. Cl. H04L 9/32

(52) U.S. Cl. CPC H04L 9/3247; H04L 9/3221

(57) ABSTRACT

Disclosed are various embodiments for binding the configuration state of client devices to the blockchain and utilizing the binding for managing cryptographic compliance. A management agent can send a request to a smart contract hosted by a blockchain network for a zero-knowledge proof (ZKP) of a configuration state for a computing device, the state including cryptographic policies. Cryptographic operations performed by the client device can be performed by complying with the policies stored on the blockchain network.

### BACKGROUND

Configurations for client devices are often managed by management services, such as mobile device management (MDM) services, unified endpoint management (UEM) services, etc. These management services can be used to ensure that managed client devices remain in compliance with various rules or policies. For example, a management service could enforce a specific device configuration or application configuration settings to ensure compliance. Moreover, updated configuration settings can be provided to client devices as changes to compliance rules or policies are made, and the changes could be enforced by the management service.

Cryptography generally involves techniques for protecting data from unauthorized access. For example, data transmitted over a network can be encrypted to protect the data from being accessed by unauthorized parties. For example, even if the encrypted data is obtained by an unauthorized party, if the unauthorized party cannot decrypt the encrypted data, then the unauthorized party cannot access the underlying data. There are many types of cryptographic algorithms, and these algorithms vary in many aspects such as key size, ciphertext size, memory requirements, computation requirements, amenability to hardware acceleration, failure handling, entropy requirements, and the like. Key size refers to the number of bits in a key used by a cryptographic algorithm. Ciphertext size refers to the number of bits in the output from a cryptographic algorithm, which may be the same as the number of bits of the input or may include padding to produce a larger number of bits than the input. Memory requirements and computation requirements generally refer to the amount of memory and processing resources required to perform an algorithm. Amenability to hardware acceleration generally refers to whether an algorithm requires or can be improved through the use of a hardware accelerator. For example, a compute accelerator is an additional hardware or software processing component that processes data faster than a central processing unit (CPU) of the computer. Failure handling refers to the processes by which an algorithm accounts for failures, such as recovering keys that are lost or deactivated. Entropy requirements generally refer to the amount of randomness required by an algorithm, such as an extent to which randomly generated values are used as part of the algorithm (e.g., which generally improves security of the algorithm).

Some cryptographic algorithms may result in a higher level of security (e.g., having more bits of security, more layers of security, larger amounts of entropy, and/or the like) than others, and there may be trade-offs with respect to resource requirements such that higher-security algorithms may require larger amounts of storage, processing, and/or communication resources (e.g., involving the transmission of larger amounts of information over a network). Furthermore, new cryptographic algorithms and libraries are developed on an ongoing basis to meet changing security needs. Cryptographic libraries are collections of cryptographic algorithms that can be invoked, such as through calls to application programming interface (API) functions provided by the libraries, to perform various cryptographic functions (e.g., encryption of data, establishing secure connection channels, and/or the like). In some cases, weaknesses in particular algorithms may be discovered over time such as due to advances in computing technology (e.g., a particular algorithm may be susceptible to being compromised using computing devices with more power than the computing devices that were in use at the time the algorithm was developed). For example, algorithms may become problematic and/or become less useful for a variety of reasons, such as due to algorithmic compromise (e.g., a weakness in the algorithm may be discovered and/or exploited), compute performance increases (e.g., the time required to “guess correctly” may be reduced), and/or the like. In some cases, new and/or updated algorithms may be developed to address these issues (e.g., by adding additional bits of security, additional layers of security, more complex forms of encryption, and/or the like).

Accordingly, a management service can require a managed device to utilize only certain cryptographic techniques or algorithms for certain applications or communications. However, relying upon a management agent or a cryptographic client on the device can result in a potential weakness in enforcement of such a requirement.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A is a drawing of a network environment according to various embodiments of the present disclosure.

FIG. 1B is a drawing of a network environment according to various embodiments of the present disclosure.

FIG. 1C is a drawing of a network environment according to various embodiments of the present disclosure.

FIG. 2 is a sequence diagram illustrating one example of functionality implemented as portions of an application executed in a computing environment in the network environment of FIG. 1 according to various embodiments of the present disclosure.

FIG. 3 is a sequence diagram illustrating one example of functionality implemented as portions of an application executed in a computing environment in the network environment of FIG. 1 according to various embodiments of the present disclosure.

### DETAILED DESCRIPTION

The present disclosure relates to cryptographic compliance utilizing an immutable and non-reputable data store, such as a blockchain hosted by a blockchain network. Configuration states that specify cryptographic rules or constraints for client devices or client applications can be set by an administrator using a management service. The management service can then publish the configuration state to a blockchain. Subsequently, a management agent executing on a client device can query the blockchain to determine whether the client device is compliant with the most recent configuration set by the management service. In some cases, before performing any cryptographic operation, which can involve communication, data storage, or data retrieval using cryptography, a cryptographic agent on a client device can query the blockchain to obtain a permitted cryptographic configuration specified for the client device by the management service. A cryptographic operation can be requested by an application on the client device that invokes a cryptographic application programming interface (API) or library. A cryptographic operation can also be requested by another device attempting to communicate with the client device using a given cryptographic technique or protocol. A cryptographic operation can comprise a communication session with another computing device that is located remotely from the computing device.

A management agent or cryptographic agent installed on a client device can perform a cryptographic operation requested by an application on the client device if the requested cryptographic technique utilized by the cryptographic operation is permitted by a configuration state corresponding to the client device that is published the blockchain. A requested cryptographic technique can encompass libraries, algorithms, configuration values, and/or the like to select based on factors such as the type of data being encrypted, the type of application requesting encryption, the network environment(s) in which the data is to be sent, a destination to which encrypted data is to be sent, geographic locations associated with a source and/or destination of the data, attributes of users associated with the encryption, regulatory environments related to the encryption, network conditions, resource availability, performance constraints, device capabilities, and/or the like.

A management service can allow users (e.g., administrators) to define policies, rules, and/or configurations. A configuration can specify rules for selecting and/or configuring cryptographic algorithms. In one example, cryptographic techniques (e.g., algorithms and/or configurations of algorithms) are tagged with different levels of security (e.g., rated from 0-10), and a policy associated with an application may specify that all data that is to be transmitted from the application to a destination in a given type of networking environment, such as a public network, is to be encrypted using a high-security algorithm (e.g., rated 8 or higher). Accordingly, if the application sends data (e.g., whether encrypted directly by the application or not), and contextual information indicates that the data is to be transmitted to a device on a public network, then the cryptographic agility system, in certain embodiments, will select a cryptographic algorithm tagged as a high-security algorithm, such as with a security rating of 8 or higher.

A configuration can allow the administrator to specify rules that a rules engine on the client device can utilize to determine whether a requested cryptographic technique for a cryptographic operation is permitted based upon the parameters associated with the request. The administrator, using the management service, can update the policies by pushing a new or updated configuration to the blockchain.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

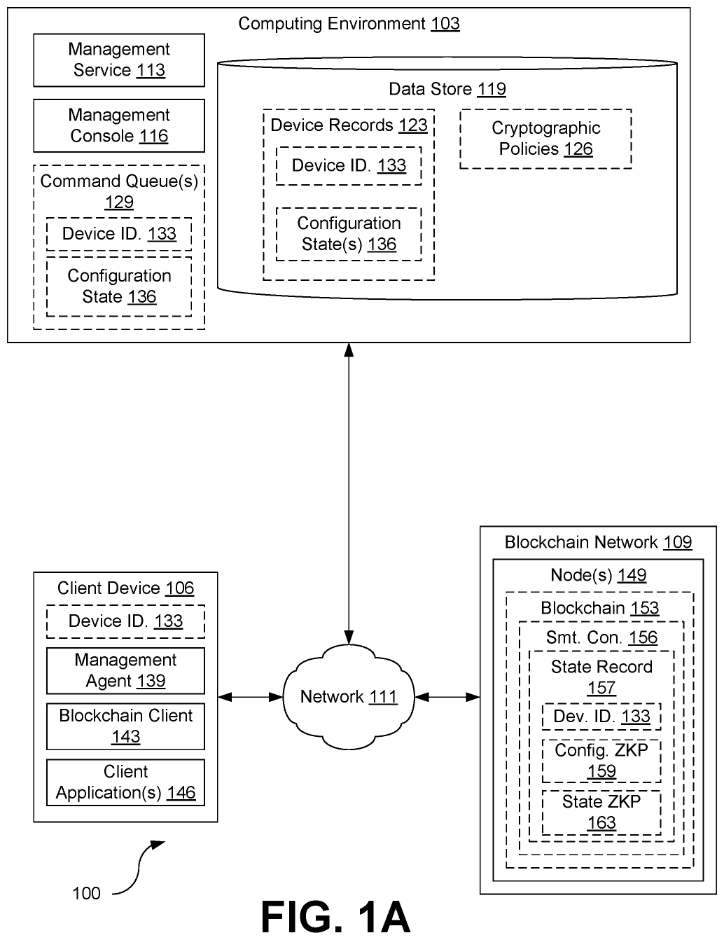

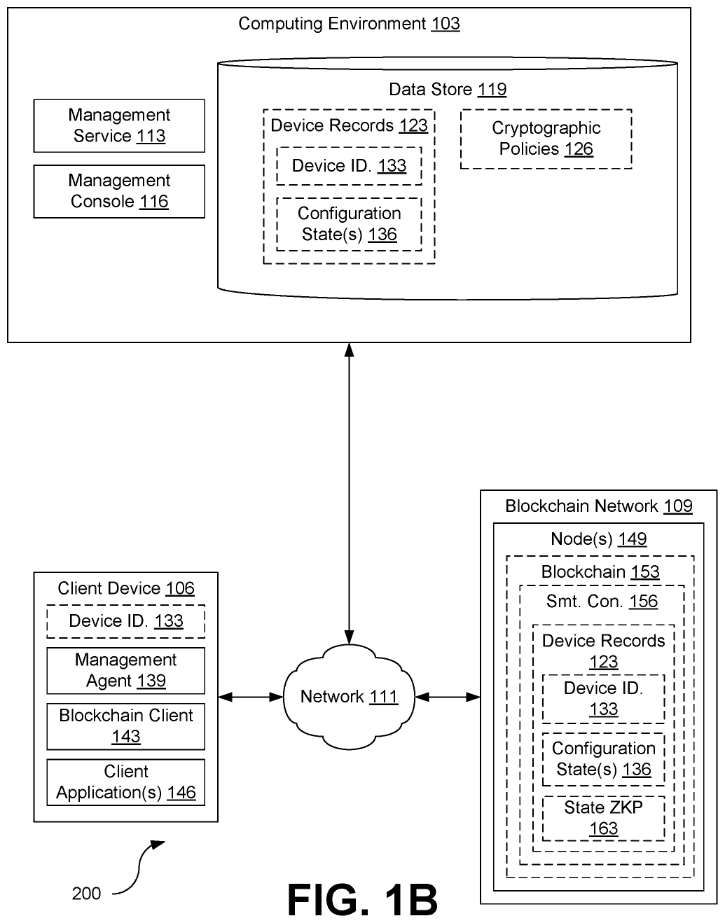

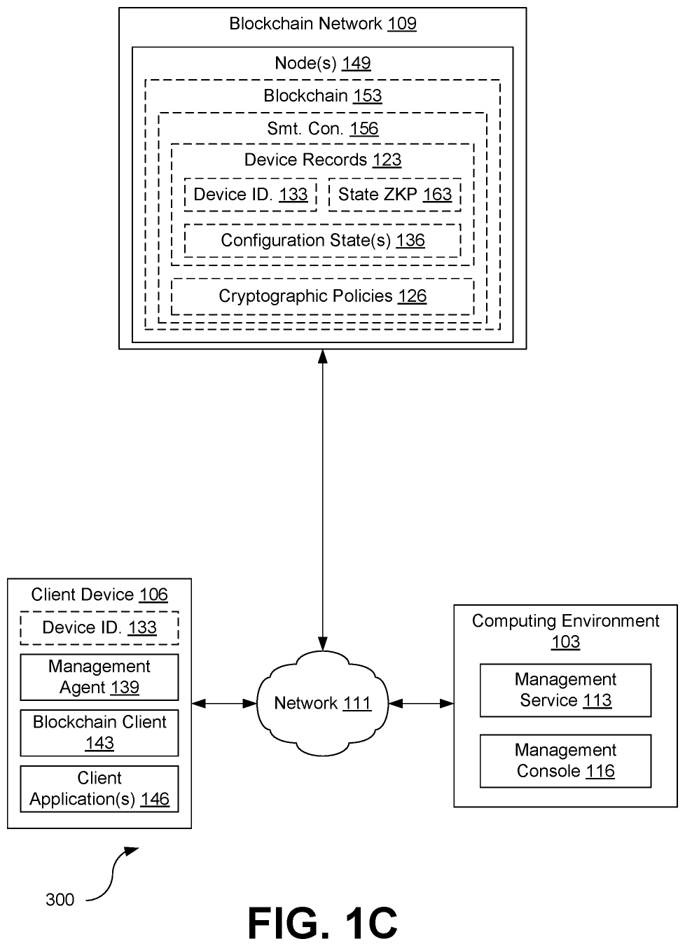

With reference to FIG. 1, shown is a network environment 100 according to various embodiments. The network environment 100 can include a computing environment 103, a client device 106, and a blockchain network 109, which can be in data communication with each other via a network 111. Although depicted separately for illustrative purposes, individual computing devices or software applications within the computing environment 103 could also be members of or participate in the blockchain network 109. Likewise, while depicted separately for illustrative purposes, the client device 106 could also be a member of or participate in the blockchain network 109.

The network 111 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (e.g., WI-FIR), BLUETOOTH® networks, microwave transmission networks, as well as other networks relying on radio broadcasts. The network 111 can also include a combination of two or more networks 111. Examples of networks 111 can include the Internet, intranets, extranets, virtual private networks (VPNs), and similar networks.

The computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 103 can employ a plurality of computing devices that can be arranged in one or more server banks or computer banks or other arrangements. Such computing devices can be in a single installation or can be distributed among many different geographical locations. For example, the computing environment 103 can include a plurality of computing devices that together can include a hosted computing resource, a grid computing resource or any other distributed computing arrangement. In some cases, the computing environment 103 can correspond to an elastic computing resource where the allotted capacity of processing, network, storage, or other computing-related resources can vary over time.

Various applications or other functionality can be executed in the computing environment 103. The components executed on the computing environment 103 can include a management service 113, a management console 116, as well as other applications, services, processes, systems, engines, or functionality. Although the management service 113 and the management console 116 are depicted separately for illustrative purposes, some or all of these applications could be combined into a single application that implements the functionality of the combined applications. Moreover, one or more of these applications could be executed on the same computing device within the computing environment 103 or on one or more separate computing devices within the computing environment 103.

Also, various data is stored in a data store 119 that is accessible to the computing environment 103. The data store 119 can be representative of a plurality of data stores 119, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 119 is associated with the operation of the various applications or functional entities described below. This data can include one or more device records 123, one or more cryptographic policy 126 as well as potentially other data.

In addition to the data stored in the data store 119, the computing environment 103 could also maintain one or more command queues 129. In some implementations, the command queues 129 could be maintained or stored in a separate data structure or location, as illustrated. In other implementations, however, the command queues 129 could be stored in the data store 119 along with the device records 123 and the cryptographic policy 126.

A device record 123 can be used to store any information related to a client device 106 enrolled with or managed by the management service 113. This can include any information about the current or last known state of the client device 106, such as applications installed on the client device or the last reported state of the client device 106. This can also include information about the user who is currently using the client device 106. Accordingly, the device record 123 can include information such as a device identifier 133, and one or more configuration states 136. A device record 123 can also be stored on the blockchain network 109 in some implementations.

The device identifier 133 can include any identifier that uniquely identifies one client device 106 with respect to another client device 106. Examples of device identifiers 133 include device names, globally unique identifiers (GUIDs), universally unique identifiers (UUIDs), network interface media access controller (MAC) addresses, international mobile equipment identity (IMEI) numbers, etc.

A configuration state 136 can represent any current or past configuration of the client device 106. The configuration state 136 can include values to be used for operating system settings for the client device 106 or for settings for individual applications installed on the client device 106. Text or markup language files (e.g., extensible markup language (XML) or yet another markup language (YAML) files) could be used to store a configuration state 136. The current configuration state 136 can be stored in a command queue 129 to be retrieved by the client device 106. The management service 113 can also publish the current configuration state 136 to the blockchain network 109 for retrieval by client devices 106.

A cryptographic policy 126 can represent one or more cryptographic policies that must be satisfied by client device 106 when applied to the client device 106. Cryptographic policies 126 can specify a range of configuration settings or options that the current configuration state 136 of the client device 106 must satisfy to be considered compliant. For example, a cryptographic policy 126 can specify one or more cryptographic algorithms, each of which may include configurable parameters, such as key size or ciphertext size. For instance, cryptographic techniques (e.g., algorithms and/or specific configurations of algorithms) may be registered with library manager along with information indicating characteristics of the cryptographic techniques. Examples of algorithms include data encryption standard (DES), triple DES, advanced encryption standard (AES), and Rivest-Shamir-Adleman (RSA). An algorithm may, for example, involve symmetric key encryption or asymmetric key encryption. A configuration of an algorithm may include values for one or more configurable parameters of the algorithm, such as key size, size of lattice, which elliptic curve is utilized, number of bits of security, whether accelerators are used, ciphertext size, and/or the like. A characteristic of a cryptographic technique may be, for example, a security rating, a resource requirement rating, whether the technique requires an accelerator, whether the technique is quantum-safe, or the like. A cryptographic technique may include more than one cryptographic algorithm and/or configuration. In an example, each cryptographic technique is tagged (e.g., by an administrator) based on characteristics of the technique, such as with a security rating, an indication of threats protected against by the technique, indications of the resource requirements of the technique, and/or the like.

Information related to cryptographic techniques can be associated with a cryptographic policy 126. For instance, a cryptographic technique can include an identifier of a library, an identifier of an algorithm in the library, and/or one or more configuration values for the algorithm. It is noted that policies and tags are examples of how cryptographic techniques may be associated with indications of characteristics, and alternative implementations are possible. For instance, rather than associating individual cryptographic techniques with tags, alternative embodiments may involve associating higher-level types of cryptographic techniques with tags, and associating individual cryptographic techniques with indications of types. For example, a higher-level type of cryptographic technique may be “symmetric key encryption algorithms configured with a key size of 200 bits or larger.” Thus, if tags are associated with this type (e.g., including security ratings, recourse requirement ratings, and the like), any specific cryptographic techniques of this type (being symmetric key encryption algorithms, and being configured with a key size of 200 bits or more) will be considered to be associated with these tags. In another example, fuzzy logic and/or machine learning techniques may be employed, such as based on historical cryptographic data indicating which cryptographic techniques were utilized for cryptographic requests having particular characteristics.

A cryptographic policy 126 can state that cryptographic requests relating to data that is long-lived (e.g., of a type that must be protected over a long amount of time, such as many years) is to be encrypted using a quantum-safe cryptographic technique if such a technique is available, unless device and/or network resource constraints prohibit the use of such a technique. Long-lived data may include, for example, classified government data, certain types of personally-identifiable information, and the like. Data that is not long-lived may include, for example, a code or password that expires after a short amount of time, a credit card number that is updated at regular intervals, network configuration data that changes on a regular basis, and the like. A cryptographic policy 126 or configuration state 136 can also be stored on the blockchain network 109 in some implementations.

Thus, an application running on a client device 106 can submit a cryptographic request (e.g., via a call to a generic cryptographic function provided by an abstracted cryptographic API) to encrypt an item of long-lived data (e.g., received from an application and directed to an endpoint), and a management agent 139 or a cryptographic agent running on the client device 106 can determine whether the request complies with a cryptographic policy 126 before performing the requested cryptographic operation.

The determination can be made based on a cryptographic policy 126 that is retrieved from a blockchain 153 according to examples of this disclosure. If the management agent 139 determines that the requested cryptographic operation for utilizing a particular cryptographic technique complies with a cryptographic policy 126 specified for the client device 106, then the new cryptographic technique for servicing the cryptographic request and provides a response to application or the proxy component accordingly. In some cases, the response sent from the management agent 139 to application or the proxy component includes data encrypted using the selected technique. In other cases, the response includes information related to performing the selected technique to encrypt the data, and the encryption is performed by the entity from which the request was sent.

In some cases, more than one cryptographic technique may be selected for servicing a given cryptographic request. For instance, an item of data may first be encrypted using a first technique (e.g., that satisfies one or more first conditions related to policy and/or resource considerations) and then the encrypted data may be encrypted again using a second technique (e.g., that satisfies one or more second conditions related to policy and/or resource considerations). A cryptographic policy 126 can specify multiple acceptable cryptographic techniques that are permitted for one or more cryptographic operations in some embodiments.

The management service 113 can manage the configuration of registered or enrolled client devices 106. This can include evaluating individual cryptographic policies 126 to determine an appropriate configuration state 136 for a client device 106 and distributing the configuration state 136 to client devices 106. The management service 113 can also provide various facilities or mechanisms to determine or otherwise ensure that enrolled client devices 106 are compliant with the applicable cryptographic policy 126.

The management console 116 can represent any user interface or user front-end to the management service 113. In some implementations, the management console 116 could be executed as a separate, independent service that interacts with the management service 113. In other implementations, the management console 116 could be a component of the management service 113. The management console 116 can represent any user interface or user front-end that allows an administrator or other user to manage, review, or analyze client devices 106 that are enrolled with the management service 113. The management console 116 could be accessible using a client device 106 over the network 111.

The client device 106 is representative of a plurality of client devices that can be coupled to the network 111. This could include physical devices embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), or other devices with like capability. This could also include virtual or logical devices, such as virtual machines, containers, etc.

The client device 106 can be configured to execute various applications such as a management agent 139, a blockchain client 143, and one or more client applications 146.

The management agent 139 can locally manage the client device 106 to enforce configuration settings specified by the management service 116 in the configuration state 136. The management agent 139 can be installed with elevated privileges or be effectuated through operating system APIs to manage the client device 106 on behalf of the management service 113. The management agent 139 can have the authority to manage data on the client device 106, install, remove, or disable certain applications, or install configuration profiles, such as VPN certificates, Wi-Fi profiles, email profiles, etc. The management agent 139 can also have the authority to enable or disable certain hardware features of the client device 106 that as specified in the configuration state 136 for the client device 106. The management agent 139 can also place the device into different hardware modes, such as airplane mode, silent mode, do-not-disturb mode, or other modes supported by the client device 106.

In examples of this disclosure, the management agent 139 can implement a cryptographic library that provides cryptographic features to applications installed on the client device 106. An application installed on the client device 106 can call generic cryptographic functions of an abstracted cryptographic API that is implemented or provided by the management agent 139 in order to invoke particular cryptographic functionality, and the management agent 139 can select cryptographic techniques and perform cryptographic operations in response to the function invocations. For example, the management agent 139 can encrypt data on behalf of the application that is being stored or transmitted to another device.

The blockchain client 143 can represent any type of software application or library that allows for the client device 106 to connect and interact with the blockchain network 109. Examples of blockchain clients 143 include full blockchain nodes 149, light blockchain clients, and stateless blockchain clients. In some implementations, the blockchain client 143 and the management agent 139 may be tightly coupled, whereby the management agent 139 is required to use the blockchain client 143 to perform various operations. In some of these implementations, the management agent 139 and the blockchain client 143 could be deployed as a single instance of an application.

The blockchain network 109 represents a peer-to-peer network of nodes 149 that utilizes a consensus protocol to maintain an immutable, append only, eventually consistent data store such as a blockchain 153. In some implementations, the blockchain network 109 could be a permissioned blockchain network 109, where only authorized nodes 149 are permitted to join or participate in the blockchain network 109. Examples of permissioned blockchain networks include HYPERLEDGER FABRIC, QUOROM, VMWARE BLOCKCHAIN, and CORDA. In other implementations, the blockchain network 109 could be permissionless, where anyone is permitted to join the blockchain network 109. Examples of public or permissionless blockchain networks 109 include the BITCOIN network, the ETHEREUM network, the SOLANA network, etc.

Nodes 149 of the blockchain network 109 can represent computing devices and/or virtual machines that maintain a copy of the blockchain 153 and all transactions submitted to the blockchain network 109 for inclusion in the blockchain 153. In some blockchain networks 109, individual nodes 149 can perform specialized functions, such as creating or validating new blocks for the blockchain 153 (sometimes referred to as “mining”), storing a copy of the current state of the blockchain 153, responding to requests for the current state of the blockchain 153, etc. In other blockchain networks 109, one or more of these functions to be performed by the same node 149.

The blockchain 153 can represent an immutable, append only, eventually consistent distributed data store maintained by a plurality of nodes 149 in a peer-to-peer network that maintain duplicate copies of data stored in the blockchain 153. The nodes 149 of the blockchain network 109 can use a variety of consensus protocols to coordinate the writing of data written to the blockchain 153. In order to store data to the blockchain 153, such as a record of a transaction of cryptocurrency coins or tokens between wallet addresses, users can pay cryptocurrency coins or tokens to one or more of the nodes 149 of the blockchain 153.

New data is written to the blockchain 153 in the form of blocks, with each block including the cryptographic hash of the previous block in the blockchain 153, thereby preventing tampering or altering of records stored in the blockchain 153. For example, whenever a new configuration state 136 is saved to a device record 123 by the management service 113, the management service 113 could save the new configuration state 136 to a new block in the blockchain 153. The management service 113 could also store the device identifier 133 of each client device 106 that the new configuration state 136 is applicable to. In some implementations, a cryptographic hash or other zero-knowledge proof of the configuration state 136 could be saved to the blockchain 153.

In some implementations, a smart contract 156 can be hosted on the blockchain 153. A smart contract can represent executable computer code that can be executed by a node 149 of the blockchain network 109. In many implementations, the smart contract 156 can expose one or more functions that can be called by any user or by a limited set of users. To execute one or more functions of a smart contract 156, an application can submit a request to a node 149 of the blockchain network 109 to execute the function. The node 149 can then execute the function and store the result to the blockchain 153. Nodes 149 may charge fees in the form of cryptocurrency coins or tokens to execute a function and store the output, with more complicated or extensive functions requiring larger fees. An example of this implementation is the ETHEREUM blockchain network, where users can pay fees, referred to as “gas,” in order to have a node of the ETHEREUM blockchain network execute the function and store the result to the ETHEREUM blockchain. Additionally, the more “gas” a user pays, the more quickly the function will be executed, and its results committed to the ETHEREUM blockchain.

The smart contract 156 can be used to store and maintain data on the blockchain related to the operation of the management service 113 and the management agent 139. For example, the smart contract 156 could maintain one or more state records 157, which could be stored on the blockchain 153. Each state record 157 could represent the current configuration state 136 for a client device 106 to remain in compliance with the cryptographic policies 126. However, because the blockchain 153 may be publicly accessible, it could be undesirable to store the current configuration state 136 itself on the blockchain 153. Accordingly, a state record 157 could include a device identifier 133 for a specific client device 106 and a state zero-knowledge proof (ZKP) 159 that represents the current state of the client device 106. The management agent 139 could generate the state ZKP 163 and submit it to the smart contract 156 to store on the blockchain 153 to prove that the current state of the client device 106 complies with the current configuration state 136 assigned by the management service 113 without explicitly disclosing the current configuration of the client device 106. The management service 113 or other applications (e.g., such as those run by auditors) could evaluate the state ZKP 163 to confirm that state the client device 106 matches the configuration state 136 specified for the client device 106. Examples of ZKPs that could be used for the state ZKP 163 can include non-interactive zero knowledge (NIZK) proofs, zero-knowledge succinct non-interactive argument of knowledge (zk-SNARK) proofs, and zero-knowledge scalable transparent argument of knowledge (zk-STARK) proofs.

FIG. 1B depicts a network environment 200 according to various embodiments. The network environment 200 can include a computing environment 103, a client device 106, and a blockchain network 109, which can be in data communication with each other via a network 111. Although depicted separately for illustrative purposes, individual computing devices or software applications within the computing environment 103 could also be members of or participate in the blockchain network 109. Likewise, while depicted separately for illustrative purposes, the client device 106 could also be a member of or participate in the blockchain network 109.

The network environment 200 has many of the same components as the network environment 100. For example, the computing environment 103 can execute a management service 113 and a management console 116, as previously described. Moreover, the computing environment 103 can host a data store 119, which can store one or more device records 123 and one or more cryptographic policies 126. Likewise, each client device 106 can store a device identifier 133 and can also host or otherwise execute a management agent 139, blockchain client 143, and/or one or more client applications 146. Likewise, the blockchain network 109 can be formed from one or more nodes 149 that host a blockchain 153. The blockchain 153 can store various data or executable programs, such as the smart contract 156. Unlike the network environment 100 of FIG. 1A, the smart contract 156 of the blockchain 153 can store one or more of the device records 123, which can include the device identifier 133 for each device record 123 as well as one or more configuration states 136.

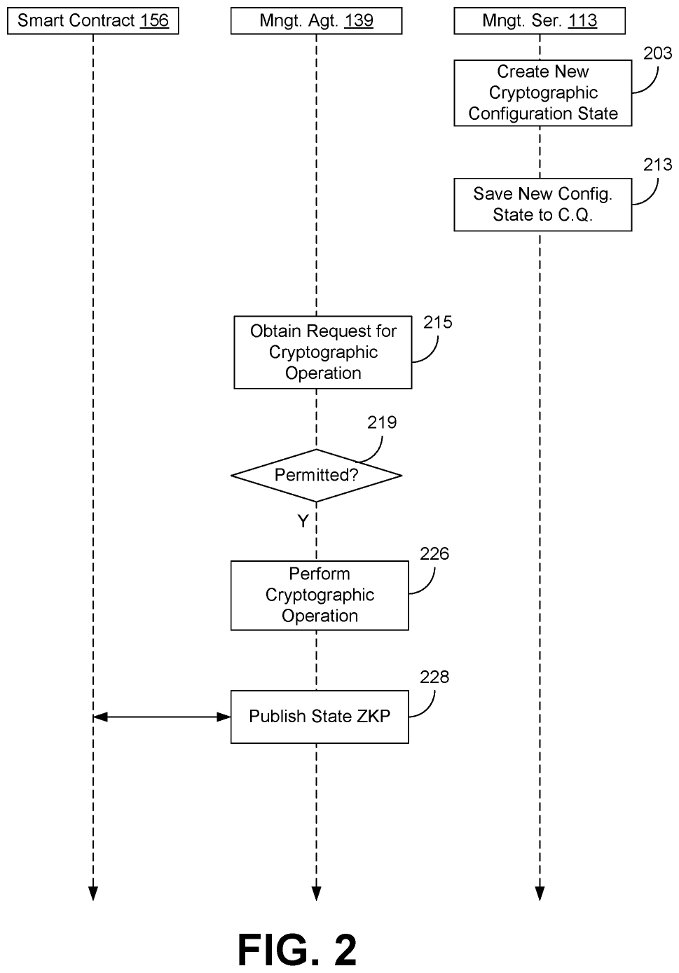

In implementations such as those depicted in the network environment 200 of FIG. 2, the configuration state 136 of a client device 106 is tightly coupled to the blockchain 153, providing for verifiability, auditability, and irreputability. The management service 113 can create and store device records 123 on the blockchain 153 by interacting with the smart contract 156. When a new configuration state 136 is created for a device record 123 (e.g., because the client device 106 is to become compliant with an additional, new, or modified cryptographic policy 126), the new configuration state 136 can be saved to the appropriate device record 123 in the data store 119. Subsequently, the management service 113 can publish the new configuration state 136 to the blockchain by interacting with the smart contract 156. The blockchain client 143 can later retrieve the current or latest configuration state 136 from the device record 123 stored by the smart contract 156, and the configuration state 136 can be applied to the client device 106 by the management agent 139.

FIG. 1C depicts a network environment 300 according to various embodiments. The network environment 300 can include a computing environment 103, a client device 106, and a blockchain network 109, which can be in data communication with each other via a network 111. Although depicted separately for illustrative purposes, individual computing devices or software applications within the computing environment 103 could also be members of or participate in the blockchain network 109. Likewise, while depicted separately for illustrative purposes, the client device 106 could also be a member of or participate in the blockchain network 109.

The network environment 300 has many of the same components as the network environment 100. For example, the computing environment 103 can execute a management service 113 and a management console 116, as previously described. Likewise, each client device 106 can store a device identifier 133 and can also host or otherwise execute a management agent 139, blockchain client 143, and/or one or more client applications 146. Likewise, the blockchain network 109 can be formed from one or more nodes 149 that host a blockchain 153. The blockchain 153 can store various data or executable programs, such as the smart contract 156. Unlike the network environment 100 of FIG. 1 or the network environment 200 of FIG. 1B, the smart contract 156 of the blockchain 153 can store one or more of the device records 123 and one or more cryptographic policies 126. The device records 123 stored by the smart contract 156 on the blockchain 153 can include the device identifier 133 for each device record 123 as well as one or more configuration states 136.

In implementations such as those depicted in the network environment 300 of FIG. 5, the configuration state 136 of a client device 106 and the cryptographic policies 126 to be enforced are tightly coupled to the blockchain 153, providing for verifiability, auditability, and irreputability. The management service 113 can create and store device records 123 and cryptographic policies 126 on the blockchain 153 by interacting with the smart contract 156. When a new configuration state 136 is created for a device record 123 (e.g., because the client device 106 is to become compliant with an additional, new, or modified cryptographic policy 126), the new configuration state 136 can be saved to the appropriate device record 123 in the data store 119. Subsequently, the management service 113 can publish the new configuration state 136 to the blockchain by interacting with the smart contract 156. The blockchain client 143 can later retrieve the current or latest configuration state 136 from the device record 123 stored by the smart contract 156, and the configuration state 136 can be applied to the client device 106 by the management agent 139.

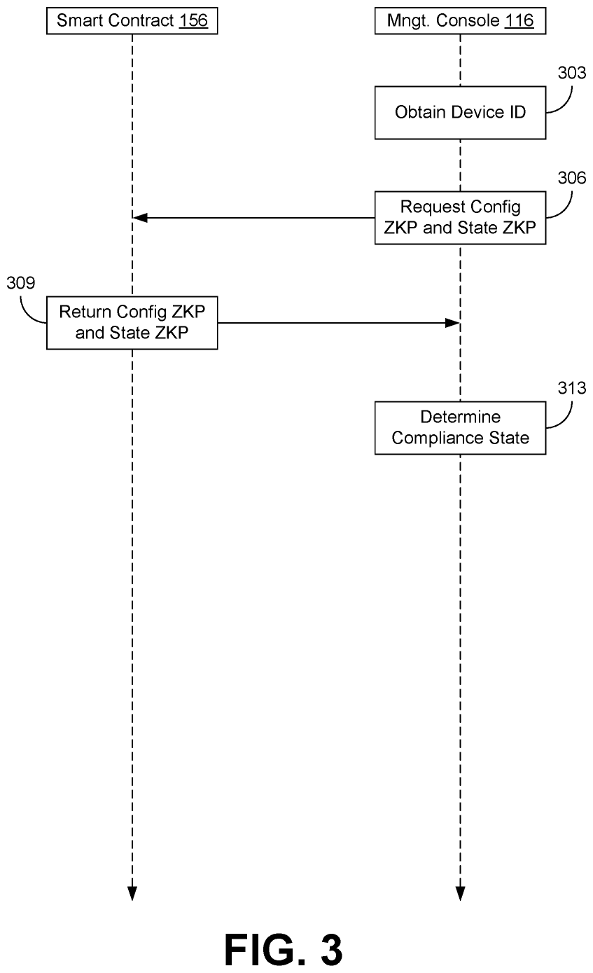

Next, a general description of the operation of the various components of the network environment 100 is provided. Although the following description provides an example of the operation of the network environment 100, other interactions between the various components of the network environment 100 are also included within the scope of the various embodiments of the present disclosure. More detailed descriptions of the operations of specific components of the network environment 100 are provided in the discussion accompanying FIGS. 2 and 3.

To begin, the management service 113 can enroll one or more client devices 106 for mobile device management or unified endpoint management (UEM) services. Accordingly, the management service 113 can identify and authenticate one of the client devices 106 and store data related to the client device 106 in a device record 123 for later reference. In some cases, the management service 113 can also be registered as a device administrator of the client device 106, permitting the management service 113 to configure and manage certain operating aspects of the client device 106. In other cases, the operating system of the client device 106 can be configured to obtain a configuration state 136 from the blockchain network 109 regarding cryptographic operations that are requested by applications on the client device 106.

In one embodiment, once a client device 106 is enrolled for device management by the management service 113, the management service 113 can create an individual command queue 129 for the client device 106 and/or assign the client device 106 to one or more group command queues 129. An individual command queue 129 could be maintained for client device 106 specific commands or configurations. Group command queues 129 could be maintained for commands or configurations that are applicable to groups of client devices 106 (e.g., all client devices 106 within an organization or department, all client devices 106 of a particular type, etc.).

The management service 113 can also determine which cryptographic policy 126 is applicable to the enrolled or registered client device 106 and create an appropriate configuration state 136 for the client device 106. For example, the management service 113 could evaluate any groups or roles that the client device 106 has been assigned to, and then select any cryptographic policy 126 assigned to those groups or roles. Moreover, the management service 113 could evaluate any cryptographic policy 126 assigned to the client device 106 specifically (e.g., because an administrator using the management console 116 assigned the cryptographic policy 126 to the client device 106). As a result of the evaluation, the management service 113 could generate a configuration state 136 for the client device 106 and save the configuration state 136 to the appropriate device record 123.

The management service 113 can then distribute the configuration state 136 to the client device 106. For example, the management service 113 could save the configuration state 136 to the appropriate command queue 129 for the client device 106. In examples of this disclosure, the management service 113 could create and save a copy of the new configuration state 136 associated with the device identifier 133 of the device record 123 of the client device 106 to a new block 156 in the blockchain 153. In some instances, the configuration state 136 itself could be saved, while in other instances, a zero-knowledge proof of the configuration state 136 could be saved to the block 156 of the blockchain 153.

Meanwhile, the management agent 139 executing on the client device 106 can periodically retrieve a cryptographic policy 126 corresponding to the client device 106 from the blockchain network 109. For example, the management agent 139 could use the blockchain client 143 to obtain the latest version of the configuration state 136 published to the blockchain 153 by the management service 113. The cryptographic policy 126 included in the configuration state 136 can be stored onto the client device 106 for reference by the management agent 139. In another scenario, whenever an application on the client device 106 requests a cryptographic operation, such as encryption of data or cryptographically secured use of network capabilities of the client device 106, the management agent 139 can retrieve a configuration state 136 corresponding to the client device 106 from the blockchain network 109 and determine whether the requested operation is permitted by the cryptographic policy 126. The management agent 139 could then apply the configuration state 136 retrieved from the command queue 129 to the client device 106. In some implementations, the management agent 139 could then publish to the blockchain 153 an acknowledgement of its current configuration state 136 as proof that the client device 106 is currently in a compliant state.

Referring next to FIG. 2, shown is a sequence diagram that provides one example of the interactions between the management service 113, the management agent 139, and the smart contract 156. The sequence diagram of FIG. 2 provides merely an example of the many different types of functional arrangements that can be employed to implement the operations of the depicted portions of the management service 113, the management agent 139, and the smart contract 156. As an alternative, the sequence diagram of FIG. 2 can be viewed as depicting an example of elements of a method implemented within the network environment 100.

Beginning with block 203, the management service 113 can create a new configuration state 136 for a client device 106. This could happen in response to a number of events. For example, when a client device 106 is first registered or enrolled with the management service 113, the management service 113 could create an initial configuration state 136 for the client device 106 based at least in part on the applicable cryptographic policies 136. As another example, when changes to the cryptographic policy 126 applicable to a client device 106 are made, an updated configuration state 136 could be created by the management service 113. Examples of changes to the cryptographic polices 126 can include the creation or removal of cryptographic policy 126 or the modification of an existing cryptographic policy 126. Once the new configuration state 136 is created for the client device 106, it can be stored in the device record 123 corresponding to the client device 106.

Meanwhile, at block 213, the management service 113 can save the new configuration state 136 to the appropriate command queue 129 for the client device 106. For example, the management service 113 could search for a command queue 129 with a matching device identifier 133. The management service 113 could then add the configuration state 136 to the command queue 129.

At block 215, the management agent 139 can obtain a request for a cryptographic operation. In one example, a client application 146 running on the client device 106 can make an API call to a cryptographic library provided by the operating system or the management agent 139 on the client device 106. The management agent 139 can provide a library that can receive API calls (e.g., calls to functions of an abstracted crypto API). In some cases, these calls can be redirected to a cryptographic provider or application on the client device 106.

The management agent 139 can generally perform operations related to dynamically selecting cryptographic techniques (e.g., based on contextual information related to requests for cryptographic operations), performing the requested cryptographic operations according to the selected techniques, and providing results of the operations to the requesting components. Cryptographic techniques may include cryptographic algorithms (e.g., included in one or more libraries) and/or specific configurations of cryptographic algorithms.

In certain aspects, the management agent 139 or a cryptographic component on the client device 106 can provide a policy manager and/or a library manager. Policy manager can perform operations related to cryptographic policies, such as receiving policies defined by users and storing information related to the policies in a policy table. In an example, the cryptographic policy 126 can be based on one or more of an organizational context and a user context related to a cryptographic request.

Organizational context may involve geographic region (e.g., country, state, city and/or other region), industry mandates (e.g., security requirements of a particular industry, such as related to storage and transmission of medical records), government mandates (e.g., laws and regulations imposed by governmental entities, such as including security requirements), and the like. For instance, a cryptographic policy 126 can indicate that if a cryptographic request is received in relation to a device or application associated with a particular geographic region, associated with a particular industry, and/or within the jurisdiction of a particular governmental entity, then the management agent 139 must select a cryptographic technique that meets one or more conditions (e.g., having a particular security rating and/or being configured to protect against particular types of threats) in order to comply with relevant laws, regulations, or mandates.

A user context can involve user identity (e.g., a user identifier or category, which may be associated with particular privileges), data characteristics (e.g., whether the data is sensitive, classified, or the like), application characteristics (e.g., whether the application is a business application, an entertainment application, or the like), platform characteristics (e.g., details of an operating system), device characteristics (e.g., hardware configurations and capabilities of the device, resource availability information, and the like), device location (e.g., geographic location information, such as based on a satellite positioning system associated with the device), networking environment (e.g., a type of network to which the device is connected, such as a satellite or land-based network connection), and/or the like. For example, cryptographic policy 126 may indicate that if a cryptographic request is received in relation to a particular category of user (e.g., administrators, general users, or the like), relating to a particular type of data (e.g., tagged as sensitive or meeting characteristics associated with sensitivity, such as being financial or medical data), associated with a particular application or type of application, associated with a particular platform (e.g., operating system), associated with a device with particular capabilities or other attributes (e.g., a client or server device having a certain amount of processing or memory resources, or having an accelerator), and/or in relation to a device in a particular location (e.g., geographic location) or type of networking environment (e.g., cellular network, satellite-based network, land network, or the like), then the management agent 139 should select a cryptographic technique that meets one or more conditions. In some cases, a cryptographic policy 126 may relate to resource constraints (e.g., based on available processing, memory, or network resources), such as specifying that cryptographic techniques must be selected based on resource availability (e.g., how much of a device's processing and/or memory resources are currently utilized, how much latency is present on a network, and the like) and/or capabilities (e.g., whether a device is associated with an accelerator) associated with devices and/or networks, while in other embodiments management agent 139 selects cryptographic techniques based on resource constraints independently of policy (e.g., for all cryptographic requests regardless of whether any policies are in place). For example, policies may only relate to security levels of cryptographic techniques, such as requiring the use of cryptographic techniques associated with particular security ratings when certain characteristics are indicated in contextual information related to a cryptographic request, and resource constraints may be considered separately from policies. In one example, once all cryptographic techniques meeting the security requirements for a cryptographic request are identified based on policies, a cryptographic technique is selected from these policy-compliant cryptographic techniques based on resource constraints.

A policy table on the client device 106 can store information related to policies, such as a cryptographic policy 126 obtained from the blockchain network 109 or the management service 113. In some embodiments, a policy table maps various contextual conditions (e.g., relating to organizational context and/or user context) to cryptographic technique characteristics (e.g., security ratings, threats protected against, resource utilization ratings, and the like). For example, a contextual condition may be the use of a certain type of application, a certain type of data, or a particular geographic location. A cryptographic technique characteristic may be, for example, a security rating (e.g., 0-10), whether the cryptographic technique is quantum-safe, what level of resource requirements the cryptographic technique has for a particular type of resource (e.g., memory, processor, or network resources), or the like. Thus, when cryptographic requests are received, a policy table or rules engine can be used to determine whether the cryptographic requests are associated with any characteristics included in policies and, if so, what cryptographic technique characteristics are required by the policies for servicing the requests.

The management agent 139 can also incorporate a library manager that manages cryptographic libraries containing cryptographic algorithms. For example, crypto libraries can include various cryptographic algorithms, each of which may include configurable parameters, such as key size or ciphertext size. For instance, cryptographic techniques (e.g., algorithms and/or specific configurations of algorithms) may be registered with the management agent 139 along with information indicating characteristics of the cryptographic techniques. Examples of algorithms include data encryption standard (DES), triple DES, advanced encryption standard (AES), and Rivest-Shamir-Adleman (RSA). An algorithm may, for example, involve symmetric key encryption or asymmetric key encryption. A configuration of an algorithm may include values for one or more configurable parameters of the algorithm, such as key size, size of lattice, which elliptic curve is utilized, number of bits of security, whether accelerators are used, ciphertext size, and/or the like. A characteristic of a cryptographic technique may be, for example, a security rating, a resource requirement rating, whether the technique requires an accelerator, whether the technique is quantum-safe, or the like. A cryptographic technique may include more than one cryptographic algorithm and/or configuration. In an example, each cryptographic technique is tagged (e.g., by an administrator) based on characteristics of the technique, such as with a security rating, an indication of threats protected against by the technique, indications of the resource requirements of the technique, and/or the like.

Information related to cryptographic techniques registered with a library manager can be stored on the client device 106 and specified by the cryptographic policy 126. For instance, information about each available cryptographic technique (e.g., an identifier of a library, an identifier of an algorithm in the library, and/or one or more configuration values for the algorithm) associated with tags indicating characteristics of the technique can be made available to the management agent 139. It is noted that policies and tags are examples of how cryptographic techniques may be associated with indications of characteristics, and alternative implementations are possible. For instance, rather than associating individual cryptographic techniques with tags, alternative embodiments may involve associating higher-level types of cryptographic techniques with tags and associating individual cryptographic techniques with indications of types. For example, a higher-level type of cryptographic technique may be “symmetric key encryption algorithms configured with a key size of 200 bits or larger.” Thus, if tags are associated with this type (e.g., including security ratings, recourse requirement ratings, and the like), any specific cryptographic techniques of this type (being symmetric key encryption algorithms, and being configured with a key size of 200 bits or more) will be considered to be associated with these tags. In another example, fuzzy logic and/or machine learning techniques may be employed, such as based on historical cryptographic data indicating which cryptographic techniques were utilized for cryptographic requests having particular characteristics.

Subsequently, at block 216, the management agent 139 can request the configuration ZKP 159 from the smart contract 156 as a pre-execution requirement for selecting a cryptographic technique utilized for the cryptographic operation. This could also occur periodically (e.g., every few minutes, every hour, every few hours, every day, etc.) or in response to various triggering events, such as receiving the request to perform a cryptographic operation from an application on the client device 106. For example, the management agent 139 could use the blockchain client 143 to make a function call to the smart contract 156 with the device identifier 133 of the client device 106 provided as an argument. In response, the smart contract 156 could search for a matching state record 157 and return the configuration ZKP 159 stored in the state record 157. The configuration ZKP 159 can include a representation of a cryptographic policy 126 that can be extracted by the management agent 139.

Proceeding to block 219, the management agent 139 can evaluate the configuration ZKP 159 returned by the smart contract 156 to determine whether the management agent 139 requested cryptographic operation is permitted by the cryptographic policy 126 embodied in the configuration ZKP 159. If the management agent 139 determines that requested cryptographic operation is not permitted by the cryptographic policy 126, the process can proceed to completion and the process could end. In some cases, in the case of a communication session with another device located remotely from the client device 106, the communication session can be terminated. However, if the management agent 139 determines that the requested cryptographic operation is permitted by the cryptographic policy 126, the process can continue to block 226.

In some implementations, upon obtaining the configuration ZKP 159 and retrieving the management agent 139 can connect to the management service 113 to retrieve the current or most recent configuration state 136 from the command queue 129. The current or most recent configuration state 136 can include the cryptographic policy 126 that corresponds to the client device 106. For example, the management agent 139 could send a request that includes the device identifier 133 of the client device 106. The management service 113 could then search for a matching command queue 129 and return the configuration state 136 stored in the command queue 129 assigned to the client device 106. The management service 113 could then remove the configuration state 136 from the command queue 129.

Next, at block 226, the management agent 139 can perform the requested cryptographic operation on behalf of the requesting application or other client device 106. In some examples, the management agent 139 can publish a state ZKP 163 to the blockchain network 109 that describes the state of a cryptographic operation performed by the management agent 139 on behalf of a requesting application. The state ZKP 163 can comprise an auditable record of the cryptographic operation and include metadata describing the data that was encrypted or transmitted, the identity of the application requesting the cryptographic operation, and the cryptographic technique that was utilized by the management agent 139 to perform the operation. Writing an auditable record of a cryptographic operation to a distributed ledger can be accomplished utilizing systems and methods as described in U.S. patent application Ser. No. 17/385,489 entitled MECHANISM FOR UNALTERABLE, NONREPUDIABLE CONFIGURATION AUDITING WITHIN CRYPTOGRAPHIC SELECTION SCHEMES, which is incorporated herein by reference in its entirety. In some examples, the management agent 139 can obtain a second ZKP from the smart contract of an updated configuration state for the client device 106, the updated configuration state including a second cryptographic technique permitted for the cryptographic operation. In this scenario, the management agent 139 can terminate the cryptographic operation using another cryptographic technique specified by the second ZKP.

Finally, at block 228, the management agent 139 could publish the state ZKP 163 to the blockchain 153 as a confirmation that the configuration state 136 has been applied to the client device 106. For example, the management agent 139 could invoke a function provided by the smart contract 153 and provide the device identifier 133 of the client device 106 and the state ZKP 163 as arguments to the function. The smart contract 153 could then identify the state record 157 with the matching device identifier 133 and store the state ZKP 163 in the state record 157 (e.g., by replacing the previously stored state ZKP 163). In some examples, a configuration state containing a cryptographic policy 136 can be published to a smart contract 156 by the management service 113 instead of being provided directly to the management agent 139 using the command queue. In turn, the management agent 139 can retrieve the cryptographic policy 136 from the smart contract 156. Other mechanisms for providing and auditing a configuration of a system are described in U.S. patent application Ser. No. 18/087,959, which is hereby incorporated by reference herein in its entirety.

Referring next to FIG. 3, shown is a sequence diagram that provides one example of how the compliance of a client device 106 with the cryptographic policy 126 could be audited or confirmed. Although the interactions are depicted between the management console 116 and the smart contract 156, other applications or services could interact with the smart contract 153 for similar purposes and to similar effect. The sequence diagram of FIG. 3 provides merely an example of the many different types of functional arrangements that can be employed to implement the operation of the depicted portions of the management console 116 and smart contract 156. As an alternative, the sequence diagram of FIG. 3 can be viewed as depicting an example of elements of a method implemented within the network environment 100.

Beginning with block 303, the management console 116 can obtain a device identifier 133 for a client device 106. For example, an administrative user could use the management console 116 to select a client device 106 for further review. The management console 116 could then retrieve the device identifier 133 from the device record 123 for the selected client device 106. As another example, the administrative user could manually provide (e.g., via manual input through the user interface of the client device 106, file upload, to the management console 106, etc.) the device identifier 133 of the client device 106 to be evaluated.

Next, at block 306, the management console 116 could send a request to the smart contract 156 for the config ZKP 159 and the state ZKP 163 of the client device 106. For example, the management console 116 could make a function call for a function provided by the smart contract 156. The argument to the function could include the device identifier 133 of the client device 106.

In response, at block 309, the smart contract 156 could search for a state record 157 with a matching device identifier 133. If a matching state record 157 exists, the smart contract 156 could retrieve and return the config ZKP 159 and the state ZKP 163 stored in the state record 157.

Subsequently, at block 313, the management console 116 (or any other application) can determine the compliance state of the client device 106 based at least in part on a comparison of the config ZKP 159 and the state ZKP 163. The compliance state can refer to a status of one or more previous cryptographic operations performed by the management agent 139 on the client device 106. The status can include the network properties, the type of data encrypted, the amount of data encrypted, a timestamp, an encryption technique or encryption algorithm utilized, and other metadata associated with the cryptographic operations. If the cryptographic operation performed by the management agent 139 of the client device 106 is compliant with the configuration specified by the management service 113, then the process could end. However, if the comparison of the config ZKP 159 with the state ZKP 163 indicates that the client device 106 is in a non-compliant state, further actions could be taken. These actions could include logging the non-compliance of the client device 106, generating an alert regarding the non-compliance, isolating or quarantining the client device 106 from various network or computer resources, or other remedial actions.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive a request to perform a cryptographic operation related to an application;
select a cryptographic technique for performing the cryptographic operation based at least in part upon contextual information associated with the request, characteristics of a plurality of cryptographic techniques, or one or more policies;
send a request to a smart contract hosted by a blockchain network for a zero-knowledge proof (ZKP) of a configuration state for the computing device, the request comprising a device identifier for the computing device;
receive the ZKP from the smart contract;
determine that the cryptographic operation or the cryptographic technique is permitted by the configuration state for the computing device based at least in part on the ZKP received from the smart contract; and
in response to determining that the cryptographic operation is permitted by the configuration state, perform the cryptographic operation using the cryptographic technique.

2. The system of claim 1, wherein the machine-readable instructions further cause the computing device to at least:
generate a confirmation that the cryptographic operation has been performed according to the cryptographic technique; and
publish the confirmation to the blockchain network.

3. The system of claim 2, wherein the ZKP is a first ZKP and the confirmation is a second ZKP that confirms that the cryptographic operation has been performed according to the cryptographic technique.

4. The system of claim 1, wherein the machine-readable instructions further cause the computing device to at least:
obtain a second ZKP from the smart contract of an updated configuration state for the computing device, the updated configuration state comprising a second cryptographic technique permitted for the cryptographic operation, the request comprising a device identifier for the computing device;
terminate the cryptographic operation using the cryptographic technique; and
perform the cryptographic operation using the second cryptographic technique.

5. The system of claim 1, wherein the cryptographic operation comprises a cryptographic technique utilizing for communication with a second computing device that is located remotely from the computing device.

6. The system of claim 1, wherein the machine-readable instructions further cause the computing device to at least send the request to the smart contract hosted by the blockchain network and receive the ZKP from the smart contract as a pre-execution requirement for selecting the cryptographic technique.

7. The system of claim 1, wherein the machine readable instructions further cause the computing device to terminate a communication session with a second computing device in response to determining that the cryptographic operation or the cryptographic technique is not permitted by the configuration state for the computing device based at least in part on the ZKP received from the smart contract.

8. A method, comprising:
receive a request to perform a cryptographic operation related to an application;
select a cryptographic technique for performing the cryptographic operation based at least in part upon contextual information associated with the request, characteristics of a plurality of cryptographic techniques, or one or more policies;
send a request to a smart contract hosted by a blockchain network for a zero-knowledge proof (ZKP) of a configuration state for the computing device, the request comprising a device identifier for the computing device;
receive the ZKP from the smart contract;
determine that the cryptographic operation or the cryptographic technique is permitted by the configuration state for the computing device based at least in part on the ZKP received from the smart contract; and
in response to determining that the cryptographic operation is permitted by the configuration state, perform the cryptographic operation using the cryptographic technique.

9. The method of claim 8, further comprising:
generate a confirmation that the cryptographic operation has been performed according to the cryptographic technique; and
publish the confirmation to the blockchain network.

10. The method of claim 9, wherein the ZKP is a first ZKP and the confirmation is a second ZKP that confirms that the cryptographic operation has been performed according to the cryptographic technique.

11. The method of claim 8, further comprising:
obtain a second ZKP from the smart contract of an updated configuration state for the computing device, the updated configuration state comprising a second cryptographic technique permitted for the cryptographic operation, the request comprising a device identifier for the computing device;
terminate the cryptographic operation using the cryptographic technique; and perform the cryptographic operation using the second cryptographic technique

12. The method of claim 8, wherein the cryptographic operation comprises a cryptographic technique utilizing for communication with a second computing device that is located remotely from the computing device.

13. The method of claim 8, further comprising sending the request to the smart contract hosted by the blockchain network and receive the ZKP from the smart contract as a pre-execution requirement for selecting the cryptographic technique

14. The method of claim 8, further comprising terminating a communication session with a second computing device in response to determining that the cryptographic operation or the cryptographic technique is not permitted by the configuration state for the computing device based at least in part on the ZKP received from the smart contract.

15. A non-transitory, computer-readable medium, comprising machine-readable instructions that, when executed by a processor of a computing device, cause the computing device to at least:
receive a request to perform a cryptographic operation related to an application;
select a cryptographic technique for performing the cryptographic operation based at least in part upon contextual information associated with the request, characteristics of a plurality of cryptographic techniques, or one or more policies;
send a request to a smart contract hosted by a blockchain network for a zero-knowledge proof (ZKP) of a configuration state for the computing device, the request comprising a device identifier for the computing device;
receive the ZKP from the smart contract;
determine that the cryptographic operation or the cryptographic technique is permitted by the configuration state for the computing device based at least in part on the ZKP received from the smart contract; and
in response to determining that the cryptographic operation is permitted by the configuration state, perform the cryptographic operation using the cryptographic technique.

16. The non-transitory, computer-readable medium of claim 15, wherein the machine-readable instructions further cause the computing device to at least:
generate a confirmation that the cryptographic operation has been performed according to the cryptographic technique; and
publish the confirmation to the blockchain network.

17. The non-transitory, computer-readable medium of claim 16, wherein the ZKP is a first ZKP and the confirmation is a second ZKP that confirms that the cryptographic operation has been performed according to the cryptographic technique.

18. The non-transitory, computer-readable medium of claim 15, wherein the cryptographic operation comprises a cryptographic technique utilizing for communication with a second computing device that is located remotely from the computing device.

19. The non-transitory, computer-readable medium of claim 15, wherein the machine-readable instructions that cause the computing device the computing device to at least send the request to the smart contract hosted by the blockchain network and receive the ZKP from the smart contract as a pre-execution requirement for selecting the cryptographic technique.

20. The non-transitory, computer-readable medium of claim 15, wherein the machine-readable instructions further cause the computing device to at least terminate a communication session with a second computing device in response to determining that the cryptographic operation or the cryptographic technique is not permitted by the configuration state for the computing device based at least in part on the ZKP received from the smart contract.
